(19) United States
(12) Patent Application Publication
(10) Pub. No.: US 2018/0219257 A1
(43) Pub. Date: Aug. 2, 2018

(54) ALUMINUM-ION BATTERY

(71) Applicant: Industrial Technology Research Institute, Hsinchu (TW)

(72) Inventors: Lee-May Huang, Tainan City (TW); Chih-Hung Chen, Zhubei City (TW)

(73) Assignee: Industrial Technology Research Institute, Hsinchu (TW)

(21) Appl. No.: 15/878,783

(22) Filed: Jan. 24, 2018

Related U.S. Application Data
(60) Provisional application No. 62/450,292, filed on Jan. 25, 2017.

(51) Int. Cl. H01M 10/0567; H01M 10/054; H01M 10/0568; H01M 10/0569; H01M 4/133; H01M 4/46; H01M 4/66; H01M 4/587; H01M 2/16

(52) U.S. Cl. CPC H01M 10/0567; H01M 10/054; H01M 10/0568; H01M 10/0569; H01M 4/133; H01M 4/463; H01M 2300/0031; H01M 4/587; H01M 4/661; H01M 2/1686; H01M 2/1613; H01M 2300/0045; H01M 4/663

(57) ABSTRACT

An aluminum-ion battery is provided. The aluminum-ion battery includes a positive electrode, a separator, a negative electrode, and an electrolyte composition. The negative electrode is separated from the positive electrode by a separator. The electrolyte composition is disposed between the positive electrode and the negative electrode. The electrolyte composition includes an aluminum halide, a solvent and a compound of Formula (I)

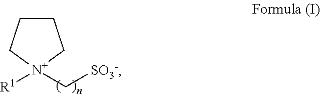

wherein R¹ is C₁₋₈ alkyl group or C₁₋₈ fluoroalkyl group; and n is 2, 3, 4, or 5. The sum of the aluminum halide and the solvent is 100 parts by weight. The compound of Formula (I) has a weight that is equal to or greater than 0.5 parts by weight and less than 5 parts by weight.

### CROSS REFERENCE TO RELATED APPLICATIONS

This application claims the benefit of U.S. Provisional Application No. 62/450,292, filed on Jan. 25, 2017, which is incorporated herein by reference.

### TECHNICAL FIELD

The technical field relates to an aluminum-ion battery.

### BACKGROUND

Aluminum is the most abundant metal on earth, and electronic devices that are based on aluminum have the advantage of being inexpensive to produce. Furthermore, aluminum has low flammability and low redox potential, which means that an aluminum-ion battery might offer significant safety improvements.

However, the electrolyte composition employed in some traditional metal-ion batteries exhibits poor stability and electrical conductivity and is apt to cause stratification, resulting in insufficient charge retention, insufficient capacity, and low power density.

Therefore, a novel aluminum-ion battery is needed to overcome the problems mentioned above.

### SUMMARY

According to embodiments of the disclosure, the disclosure provides an aluminum-ion battery. The aluminum-ion battery can include a positive electrode, a separator, and a negative electrode, wherein the negative electrode is separated from the positive electrode by the separator. An electrolyte composition is disposed between the positive electrode and the negative electrode. The electrolyte composition can include an aluminum halide, a solvent, and a compound of Formula (I)

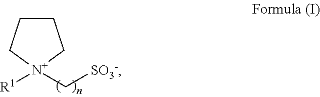

wherein R¹ can be C₁₋₈ alkyl group or C₁₋₈ fluoroalkyl group; and n can be 2, 3, 4, or 5. The sum of the aluminum halide and the solvent is 100 parts by weight, and the compound of Formula (I) has a weight that is equal to or greater than 0.5 parts by weight and less than 5 parts by weight.

According to other embodiments of the disclosure, the aluminum-ion battery of the disclosure can include a positive electrode, a separator, a negative electrode, and an electrolyte composition. The negative electrode is separated from the positive electrode by the separator, and the electrolyte composition is disposed between the positive electrode and the negative electrode. The electrolyte composition includes an aluminum halide and a solvent. The positive electrode can include a current-collecting layer, an active material layer disposed on the current-collecting layer, and a zwitterionic compound layer disposed on the active material layer, wherein the zwitterionic compound layer includes a compound of Formula (I)

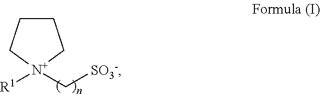

wherein R¹ is C₁₋₈ alkyl group or C₁₋₈ fluoroalkyl group; and n is 2, 3, 4, or 5.

A detailed description is given in the following embodiments with reference to the accompanying drawings.

### DESCRIPTION OF THE DRAWINGS

FIG. 1 a schematic view of the aluminum-ion battery according to an embodiment of the disclosure;

FIG. 2 a schematic view of the aluminum-ion battery according to some embodiments of the disclosure; and

FIG. 3 is a graph plotting the charging/discharging voltage against the specific capacity of the aluminum-ion battery (3) of Example 2.

### DETAILED DESCRIPTION

The aluminum-ion battery of the disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In the drawings, the size, shape, or thickness of some of the elements may be exaggerated and not drawn on scale for illustrative purposes. The disclosure will be described with respect to particular embodiments and with reference to certain drawings but the disclosure is not limited thereto.

The disclosure provides an aluminum-ion battery. According to embodiments of the disclosure, besides the aluminum halide and the solvent, the electrolyte composition of the aluminum-ion battery of the disclosure further includes a compound of Formula (I)

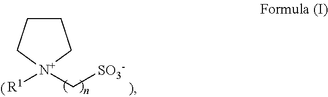

thereby improving the stability of the electrolyte composition. Therefore, the electrolyte composition is not easily decomposed during the charging/discharging of the aluminum-ion battery. As a result, the capacity and the charge retention of the aluminum-ion battery of the disclosure can be increased, thereby achieving the purpose of inhibiting self-discharge and increasing the power density and the high-voltage (charging/discharging voltage) resistance of the aluminum-ion battery.

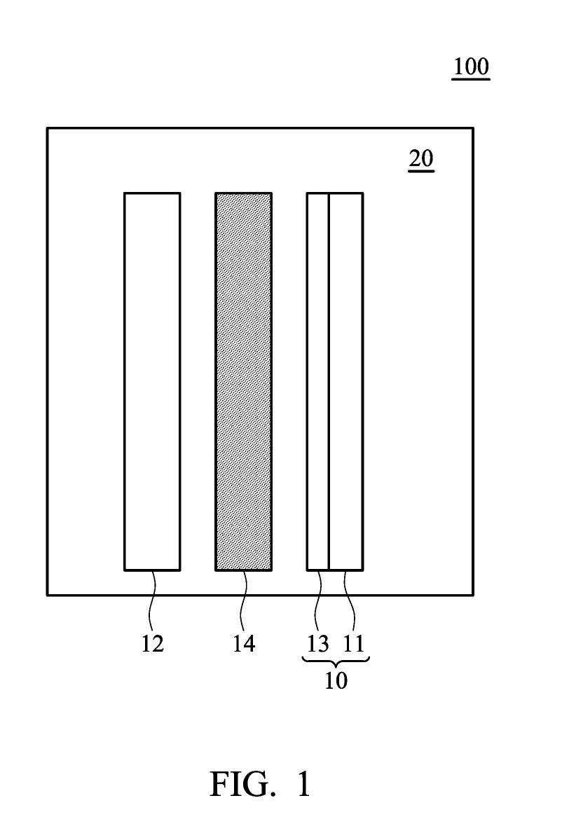

According to embodiments of the disclosure, the disclosure also provides an aluminum-ion battery. FIG. 1 is a schematic view of the aluminum-ion battery 100 according to an embodiment of the disclosure. The aluminum-ion battery 100 can include a positive electrode 10, a negative electrode 12, and a separator 14, wherein the separator 14 can be disposed between the positive electrode 10 and the negative electrode 12 to separate the negative electrode 12 and the positive electrode 10 from each other, preventing the positive electrode 10 from coming into direct contact with the negative electrode 12. The aluminum-ion battery 100 further includes an electrolyte composition 20 disposed between the positive electrode 10 and the negative electrode 12 in the aluminum-ion battery 100. Thus, the electrolyte composition 20 comes into contact with the positive electrode 10 and the negative electrode 12. The aluminum-ion battery 100 can be a rechargeable secondary battery or it can be a primary battery. According to embodiments of the disclosure, the electrolyte composition 20 of the disclosure includes an aluminum halide, a solvent, and a compound of Formula (I)

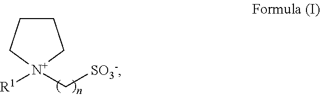

wherein R¹ is C₁₋₈ alkyl group or C₁₋₈ fluoroalkyl group; and n is 2, 3, 4, or 5. The sum of the aluminum halide and the solvent can be about 100 parts by weight, and the compound of Formula (I) has a weight that is equal to or greater than 0.5 parts by weight and less than 5 parts by weight, such as from 0.5 to 4.5 parts by weight, 0.5 to 4 parts by weight, 0.5 to 3 parts by weight, or 1 to 4 parts by weight. According to embodiments of the disclosure, when the amount of the compound of Formula (I) in the electrolyte composition is too low or too high, the electrolyte composition is apt to have a reduced stability and electrical conductivity, and the obtained electrolyte composition becomes unsuitable to use in the aluminum-ion battery. According to embodiments of the disclosure, the electrolyte composition 20 of the disclosure can consist of the aluminum halide, the solvent, and the compound of Formula (I).

According to embodiments of the disclosure, C₁₋₈ alkyl group can be linear or branched alkyl group. For example, C₁₋₈ alkyl group can be methyl group, ethyl group, propyl group, iso-propyl group, n-butyl group, tert-butyl group, sec-butyl group, iso-butyl group, pentyl group, or hexyl group. According to embodiments of the disclosure, C₁₋₈ fluoroalkyl group can be an alkyl group which a part of or all hydrogen atoms bonded on the carbon atom are replaced with fluoride atoms, and C₁₋₈ fluoroalkyl group can be linear or branched fluoroalkyl group. For example, fluoromethyl group can be monofluoromethyl group, difluoromethyl group, or trifluoromethyl group. According to embodiments of the disclosure, C₁₋₈ fluoroalkyl group can be fluoromethyl, fluoroethyl, fluoropropyl, fluoroisopropyl group, fluorobutyl group, fluoro-sec-butyl group, fluoro-iso-butyl group, fluoro-tert-butyl group, fluoropentyl group, or fluorohexyl group.

According to embodiments of the disclosure, aluminum halide can be aluminum fluoride, aluminum chloride, aluminum bromide, or aluminum iodide. According to embodiments of the disclosure, besides the aluminum halide, the electrolyte composition of the disclosure can further include other metal halide, such as silver chloride, cupric chloride, cobalt chloride, ferric chloride, zinc chloride, indium chloride, cadmium chloride, nickel chloride, tin chloride, chromium chloride, lanthanum chloride, yttrium chloride, titanium chloride, manganese chloride, molybdenum chloride, or at least two thereof. The molar ratio of the aluminum halide (or the sum of the aluminum halide and the metal halide) to the solvent can be about from 1:1 to 2.2:1. For example, the molar ratio of the aluminum halide to the solvent can be about 1.1, 1.2, 1.3, 1.4, 1.5, 1.6, 1.7, 1.8, 1.9, 2.0, 2.1 or 2.2.

According to embodiments of the disclosure, the solvent of the disclosure can be a solvent which is able to dissolve or distribute the aluminum halide. The solvent can be ionic liquid, organic solvent, or a combination thereof. According to embodiments of the disclosure, the ionic liquid can be a salt with a melting point less than 100° C. According to embodiments of the disclosure, the ionic liquid can be chlorine-containing ionic liquid. According to embodiments of the disclosure, the ionic liquid can include ammonium chloride, azaannulenium chloride, azathiazolium chloride, benzimidazolium chloride, benzofuranium chloride, benzotriazolium chloride, borolium chloride, cholinium chloride, cinnolinium chloride, diazabicyclodecenium chloride, diazabicyclononenium chloride, diazabicyclo-undecenium chloride, dithiazolium chloride, furanium chloride, guanidinium chloride, imidazolium chloride, indazolium chloride, indolinium chloride, indolium chloride, morpholinium chloride, oxaborolium chloride, oxaphospholium chloride, oxazinium chloride, oxazolium chloride, iso-oxazolium chloride, oxathiazolium chloride, pentazolium chloride, phospholium chloride, phosphonium chloride, phthalazinium chloride, piperazinium chloride, piperidinium chloride, pyranium chloride, pyrazinium chloride, pyrazolium chloride, pyridazinium chloride, pyridinium chloride, pyrimidinium chloride, pyrrolidinium chloride, pyrrolium chloride, quinazolinium chloride, quinolinium chloride, iso-quinolinium chloride, quinoxalinium chloride, selenozolium chloride, sulfonium chloride, tetrazolium chloride, iso-thiadiazolium chloride, thiazinium chloride, thiazolium chloride, thiophenium chloride, thiuronium chloride, triazadecenium chloride, triazinium chloride, triazolium chloride, iso-triazolium chloride, uronium chloride, or at least two thereof. According to embodiments of the disclosure, organic solvent can be urea, N-methylurea, dimethyl sulfoxide, methylsulfonylmethane, or at least two thereof.

According to embodiments of the disclosure, the compound of Formula (I) can be

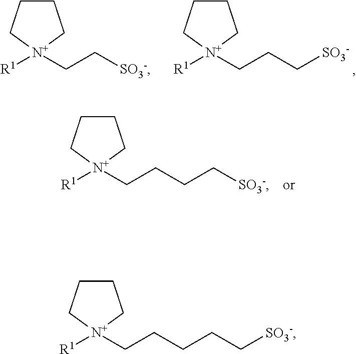

wherein R¹ is C₁₋₈ alkyl group or C₁₋₈ fluoroalkyl group. According to some embodiments of the disclosure, the compound of Formula (I) can be

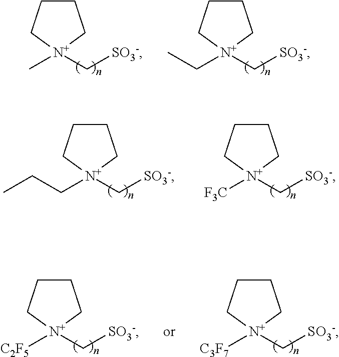

wherein n is 2, 3, 4, or 5.

According to embodiments of the disclosure, as shown in FIG. 1, the positive electrode 10 of the disclosure can include a current-collecting layer 11 and an active material layer 13 disposed on the current-collecting layer 11. According to embodiments of the disclosure, the positive electrode 10 can consist of the current-collecting layer 11 and the active material layer 13. According to embodiments of the disclosure, the current-collecting layer 11 can be conductive carbon substrate, such as carbon cloth, carbon felt, or carbon paper. The current-collecting layer 11 can be metal material such as aluminum, nickel, copper etc. In addition, the current-collecting layer 11 can be a composite of a carbon material and a metal. For example, the conductive carbon substrate has a sheet resistance from about 1 mΩ·cm⁻² to 6 mΩ·cm⁻² and the carbon content of the conductive carbon substrate is greater than about 65 wt %. According to embodiments of the disclosure, the active material layer 13 can include an active material, wherein the active material can be layered carbon material, vanadium oxide, metal sulfide, or a composite thereof. According to embodiments of the disclosure, the layered carbon material is graphite, carbon nanotube, graphene, or at least two thereof. According to embodiments of the disclosure, the layered carbon material can be intercalated carbon material, such as graphite (including natural graphite, synthetic graphite, pyrolytic graphite, foamed graphite, flake graphite or expanded graphite), graphene, carbon nanotube, or a combination thereof. The active material 13 can have the porosity in a range from about 0.05 to 0.95, such as from about 0.3 and 0.9. In addition, according to embodiments of the disclosure, the active material layer 13 can consist of the active material and the active material 13 can be growth directly on the current-collecting layer 11 (i.e. there is no other layer between the active layer and the current-collecting layer). According to some embodiments of the disclosure, active material layer 13 can include the active material and an adhesive. The active material 13 can be affixed to the current-collecting layer 11 via the adhesive. According to embodiments of the disclosure, the adhesive can be plastic resin or thermosetting resin. For example, the adhesive can be polyethylene, polypropylene, polytetrafluoroethylene (PTFE), polyvinylidenefluoride (PVDF), tetrafluoroethylene/hexafluoroethylene copolymer, tetrafluoroethylene/hexafluoropropylene copolymer (FEP), tetrafluoroethylene/perfluoroalkyl vinyl ether copolymer (PFA), vinylidenefluoride-hexafluoropropylene copolymer, polychlorotrifluoroethylene copolymer (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, carboxymethyl cellulose, or a combination thereof.

According to embodiments of the disclosure, suitable material of the separator 14 can be glass fiber, polyethylene (PE), polypropylene (PP), nonwoven fabric, wood fiber, poly(ether sulfones) (PES), ceramic fiber, or at least two thereof.

According to embodiments of the disclosure, the negative electrode 12 can be a metal or an alloy of the metal. According to the embodiments of the disclosure, the metal can be aluminum, copper, iron, zinc, indium, nickel, tin, chromium, yttrium, titanium, or molybdenum. In addition, the negative electrode 12 can further include a current-collecting layer (not shown), and the metal or the alloy of the metal is disposed on the current-collecting layer. According to embodiments of the disclosure, the metal or the alloy of the metal can be disposed directly on the current-collecting layer (i.e. there is no other layer between the active layer and the current-collecting layer). Furthermore, the active material can be affixed to the current-collecting layer via an adhesive. According to embodiments of the disclosure, the metal can have a reduction potential lower than that of aluminum, thereby solving the problem of the negative electrode corrosion of the aluminum-ion battery.

In addition, according to the other embodiments of the disclosure, the aluminum-ion battery of the disclosure can also include a positive electrode having a zwitterionic compound layer, wherein the zwitterionic compound layer includes the aforementioned compound of Formula (I). As a result, the zwitterionic compound layer can improve the capacity and the charge retention of the aluminum-ion battery, thereby achieving the purpose of inhibiting self-discharge of aluminum-ion battery and increasing the power density and the high-voltage (charging/discharging voltage) resistance of aluminum-ion battery.

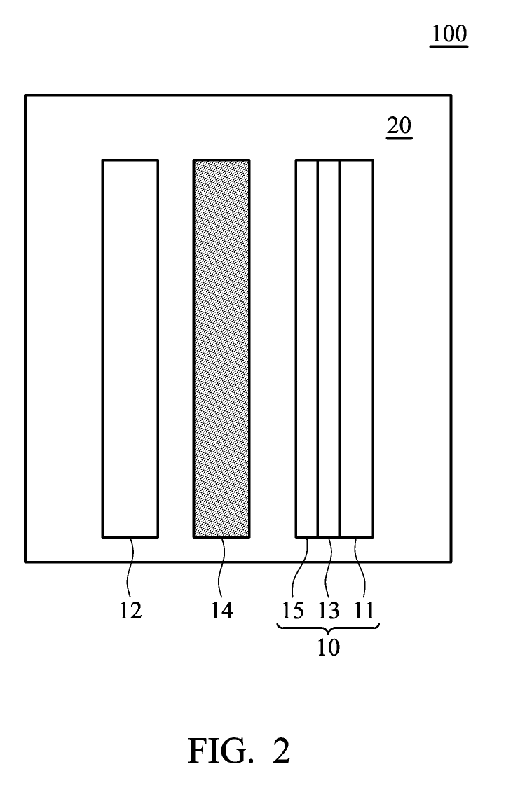

According to embodiments of the disclosure, as shown in FIG. 2, the aluminum-ion battery of the disclosure 100 can include a positive electrode 10, a negative electrode 12, a separator 14, and an electrolyte composition 20. Besides the current-collecting layer 11 and the active material layer 13, the positive electrode 10 further includes a zwitterionic compound layer 15 disposed on the active material layer 13. The zwitterionic compound layer can include the aforementioned compound of Formula (I)

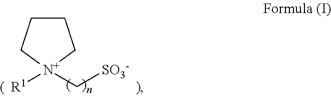

and the zwitterionic compound layer can have an average thickness from about 1 nm to 20 nm, such as about 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, or 20 nm. When the thickness of the zwitterionic compound layer is too thin or too thick, the zwitterionic compound layer will have an uneven thickness or exhibits island-shape aggregation. Herein, the positive electrode, the negative electrode, separator, the current-collecting layer, and the active material layer have the same definition as above. According to embodiments of the disclosure, the zwitterionic compound layer can consist of the aforementioned compound of Formula (I). According to embodiments of the disclosure, the electrolyte composition can include aluminum halide and solvent. According to embodiments of the disclosure, besides the aluminum halide, the electrolyte composition can further include other metal halide. Herein, the aluminum halide, the solvent, and the metal halide have the same definition as above. According to embodiments of the disclosure, electrolyte composition can include aluminum halide, solvent and the aforementioned compound of Formula (I).

According to embodiments of the disclosure, the method for forming the zwitterionic compound layer can include the following steps. First, the compound of Formula (I) of the disclosure is dissolved or dispersed in a solvent, to obtain a solution. For example, the solvent can be methanol, ethanol, or isopropanol, and the solution can have a solid content from 1 wt % to 50 wt %. Next, a current-collecting layer, which has an active material layer formed on its surface, is immersed into the solution, in order to form a layer of zwitterionic compound on the surface of the active material. Next, the current-collecting layer is subjected to a baking process (with a baking temperature ranges from 80° C. to 150° C. and a processing time of 10 min to 10 hr) to remove the solvent of the aforementioned layer, in order to obtain an electrode with zwitterionic compound layer on top of the active material layer. According to embodiments of the disclosure, the thickness of the zwitterionic compound layer can be adjusted according to the solid content of the solution. According to embodiments of the disclosure, when the active material is a layered carbon material, the aforementioned compound of Formula (I) can be introduced into the structure of the layered carbon material and attached to the surface of the layered carbon material.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity.

### PREPARATION EXAMPLE 1

1,4-butane sultone (0.1 mole) was added into a glass beaker and dissolved in acetone. Next, 1-methylpyrrolidine (0.1 mole) was added slowly into the beaker under nitrogen atmosphere. After reacting at room temperature for 120 hr, a white solid was formed. Next, the product was filtrated and washed by acetone. Next, the obtained filter cake was dried under vacuum, obtaining Compound (1) (with a structure of

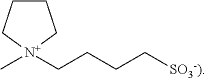

### PREPARATION EXAMPLE 2

1,4-butane sultone (0.1 mole) was added into a glass beaker, and dissolved in acetone. Next, 1-ethylimidazole (0.1 mole) was added slowly into the beaker under nitrogen atmosphere. After reacting at room temperature for 120 hr, a white solid was formed. Next, the result was filtrated and washed by acetone. Next, the obtained filter cake was dried under vacuum, obtaining Compound (2) (with a structure of

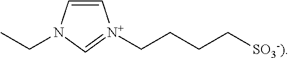

Electrolyte Composition

### PREPARATION EXAMPLE 3

Aluminum chloride was mixed with 1-ethyl-3-methylimidazolium chloride (sold by Iolitec Co.). After stirring for 1 hr, Electrolyte composition (1) was obtained, wherein the molar ratio of the aluminum chloride to the 1-ethyl-3-methylimidazolium chloride was 1.3:1.

### PREPARATION EXAMPLE 4

100 parts by weight of Electrolyte composition (1) (the molar ratio of the aluminum chloride to the 1-ethyl-3-methylimidazolium chloride was 1.3:1) was mixed with 1 part by weight of Compound (1). After stirring for 1 hr, Electrolyte composition (2) was obtained.

### PREPARATION EXAMPLE 5

100 parts by weight of Electrolyte composition (1) (the molar ratio of the aluminum chloride to the 1-ethyl-3-methylimidazolium chloride was 1.3:1) was mixed with 1.5 parts by weight of Compound (1). After stirring for 1 hr, Electrolyte composition (3) was obtained.

### PREPARATION EXAMPLE 6

100 parts by weight of Electrolyte composition (1) (the molar ratio of the aluminum chloride to the 1-ethyl-3-methylimidazolium chloride was 1.3:1) was mixed with 3 parts by weight of Compound (1). After stirring for 1 hr, Electrolyte composition (4) was obtained.

### PREPARATION EXAMPLE 7

100 parts by weight of Electrolyte composition (1) (the molar ratio of the aluminum chloride to the 1-ethyl-3-methylimidazolium chloride was 1.3:1) was mixed with 5 parts by weight of Compound (1). After stirring for 1 hr, Electrolyte composition (5) was obtained.

### PREPARATION EXAMPLE 8

100 parts by weight of Electrolyte composition (1) (the molar ratio of the aluminum chloride to the 1-ethyl-3-methylimidazolium chloride was 1.3:1) was mixed with 1.5 parts by weight of Compound (2). After stirring for 1 hr, Electrolyte composition (6) was obtained.

Aluminum-Ion Battery

### COMPARATIVE EXAMPLE 1

An aluminum foil (with a thickness of 0.025 mm, manufactured by Alfa Aesar) serving as current collecting layer was cut and assembled with a nickel plate (with a width of 3 mm) to obtain an aluminum electrode. Next, a separator (2 stacked layers of Whatman® glass microfiber filters, Grade GF/A) and a graphite electrode (the graphite electrode included an active material disposed on a current-collecting layer, wherein the current-collecting layer was a carbon fiber paper, and the active material was an expanded graphite) were provided. Next, the aluminum electrode, the separator, and the graphite electrode were placed in sequence and sealed within an aluminum plastic pouch. Electrolyte composition (1) (not including Compound (1)) was injected into the aluminum plastic pouch, obtaining Aluminum-ion battery (1).

### EXAMPLE 1

An aluminum foil (with a thickness of 0.025 mm, manufactured by Alfa Aesar) serving as current collecting layer was cut and assembled with a nickel plate (with a width of 3 mm) to obtain an aluminum electrode. Next, a separator (2 stacked layers of Whatman® glass microfiber filters, Grade GF/A) and a graphite electrode (the graphite electrode included an active material disposed on a current-collecting layer, wherein the current-collecting layer was a carbon fiber paper, and the active material was an expanded graphite) were provided. Next, the aluminum electrode, the separator, and the graphite electrode were placed in sequence and sealed within an aluminum plastic pouch. Electrolyte composition (2) (including 1 wt % of Compound (1)) was injected into the aluminum plastic pouch, obtaining Aluminum-ion battery (2).

### EXAMPLE 2

Example 2 was performed in the same manner as disclosed in Example 1, except that Electrolyte composition (2) (including 1 wt % of Compound (1)) was replaced with Electrolyte composition (3) (including 1.5 wt % of Compound (1)), obtaining Aluminum-ion battery (3).

### EXAMPLE 3

Example 3 was performed in the same manner as disclosed in Example 1, except that Electrolyte composition (2) (including 1 wt % of Compound (1)) was replaced with Electrolyte composition (4) (including 3 wt % of Compound (1)), obtaining Aluminum-ion battery (4).

### COMPARATIVE EXAMPLE 2

Comparative Example 2 was performed in the same manner as disclosed in Comparative Example 1, except that Electrolyte composition (1) (not including Compound (1)) was replaced with Electrolyte composition (5) (including 5 wt % of Compound (1)), obtaining Aluminum-ion battery (5).

### COMPARATIVE EXAMPLE 3

Comparative Example 2 was performed in the same manner as disclosed in Comparative Example 1, except that Electrolyte composition (1) (not including Compound (1)) was replaced with Electrolyte composition (6) (including 1.5 wt % of Compound (2)), obtaining Aluminum-ion battery (6).

### EXAMPLE 4

A carbon paper (available from CeTech Co., Ltd.) was provided. Next, a natural graphite powder (sold by TED PELLA with a trade number of SP-1) and polyvinylidenefluoride (PVDF) were dissolved in N-methyl-2-pyrrolidone (NMP), obtaining a paste composition (wherein the concentration of the natural graphite powder was 10 wt %). Next, the paste composition was coated on the carbon paper and was dried in a vacuum oven. After baking for 120° C. for 8 hr, a graphite electrode was obtained. Next, Compound (1) was dissolved in methanol, obtaining Zwitterionic compound solution (1) (the weight ratio of Compound (1) to methanol was 2:100). Next, the graphite electrode was immersed into Zwitterionic compound solution (1) for 10 min. After rinsing the excess Zwitterionic compound solution (1), the graphite electrode was baked at 100° C. for 30 min, to obtain a graphite electrode with Zwitterionic compound layer (1) (having a thickness of about 5.5 nm) (serving as Positive electrode (1)). In particular, the method for measuring the thickness of the zwitterionic compound layer included immersing a wafer substrate into Zwitterionic compound solution (1) and measuring the thickness of the dried zwitterionic compound layer by an ellipsometer after drying.

An aluminum foil (with a thickness of 0.025 mm, manufactured by Alfa Aesar) serving as current collecting layer was cut and assembled with a nickel plate (with a width of 3 mm) to obtain an aluminum electrode. Next, a separator (2 stacked layers of Whatman® glass microfiber filters, Grade GF/A) was provided. The aluminum electrode, the separator, and Positive electrode (1) were placed in sequence and sealed within an aluminum plastic pouch. Electrolyte composition (1) was injected into the aluminum plastic pouch, obtaining Aluminum-ion battery (7).

### EXAMPLE 5

Compound (1) was dissolved in methanol, obtaining Zwitterionic compound solution (2) (the weight ratio of Compound (1) to methanol was 5:100). Next, the graphite electrode of Example 4 was immersed into Zwitterionic compound solution (2) for 10 min. Next, after rinsing the excess Zwitterionic compound solution (2), the graphite electrode was baked at 100° C. for 30 min, to obtain a graphite electrode with Zwitterionic compound layer (2) (having a thickness of about 7.6 nm) (serving as Positive electrode (2)).

An aluminum foil (with a thickness of 0.025 mm, manufactured by Alfa Aesar) serving as current collecting layer was cut and assembled with a nickel plate (with a width of 3 mm) to obtain an aluminum electrode. Next, a separator (2 stacked layers of Whatman® glass microfiber filters, Grade GF/A) was provided. The aluminum electrode, the separator, and Positive electrode (2) were placed in sequence and sealed within an aluminum plastic pouch. Electrolyte composition (1) was injected into the aluminum plastic pouch, obtaining Aluminum-ion battery (8).

### EXAMPLE 6

Compound (1) was dissolved in methanol, obtaining Zwitterionic compound solution (3) (the weight ratio of Compound (1) to methanol was 10:100). Next, the graphite electrode of Example 4 was immersed into Zwitterionic compound solution (3) for 10 min. Next, after removing Zwitterionic compound solution (3), the graphite electrode was baked at 100° C. for 30 min, to obtain a graphite electrode with Zwitterionic compound layer (3) (having a thickness of about 8.5 nm) (serving as Positive electrode (3)).

An aluminum foil (with a thickness of 0.025 mm, manufactured by Alfa Aesar) serving as current collecting layer was cut and assembled with a nickel plate (with a width of 3 mm) to obtain an aluminum electrode. Next, a separator (2 stacked layers of Whatman® glass microfiber filters, Grade GF/A) was provided. The aluminum electrode, the separator, and Positive electrode (3) were placed in sequence and sealed within an aluminum plastic pouch. Electrolyte composition (1) was injected into the aluminum plastic pouch, obtaining Aluminum-ion battery (9).

Properties Measurement of Aluminum-Ion Battery

First, Aluminum-ion battery (1) of Comparative Example 1, Aluminum-ion battery (3) of Example 2, and Aluminum-ion battery (5) of Comparative Example 2 were charged (to about 2.45 V) and discharged (to about 0.5 V) at a current density of about 150 mA/g to measure the discharging specific capacity thereof. The results are shown in Table 1.

TABLE 1

| | | | Discharging |
|---|---|---|---|
| | AlCl₃:[EMIm]Cl | Compound (1) | specific capacity |
| | (molar ratio) | (wt %) | (mAh/g) |
| Aluminum-ion | 1.3:1 | 0 | 90 |
| battery (1) | | | |
| Aluminum-ion | 1.3:1 | 1.5 | 100 |
| battery (3) | | | |
| Aluminum-ion | 1.3:1 | 5 | 80 |
| battery (5) | | | |

As shown in Table 1, Aluminum-ion battery (3) (employing an electrolyte composition with 1.5 wt % of Compound (1)) has a discharging specific capacity of about 100 (mAh/g). In comparison with Aluminum-ion battery (1) (without Compound (1)), the discharging specific capacity of Aluminum-ion battery (3) is 1.11 times greater than that of Aluminum-ion battery (1). In addition, when increasing the concentration of Compound (1) from 1.5 wt % to 5 wt %, the discharging specific capacity of Aluminum-ion battery (5) is less than that of Aluminum-ion battery (1) (without Compound (1)).

Charging/Discharging Test

Aluminum-ion battery (1) of Comparative Example 1, Aluminum-ion battery (3) of Example 2, and Aluminum-ion battery (6) of Comparative Example 3 were subjected to a charging/discharging test (charged to about 2.6 V and discharged to about 0.5 V at a current density of about 150 mA/g). As the result, Aluminum-ion battery (1) of Comparative Example 1 appears to have an inflection point of overcharging when the charging voltage is greater than 2.5V. The aforementioned appearance is still observed when the charging/discharging exceeded 100 cycles. The unstable charging/discharging phenomenon of Aluminum-ion battery (1) of Comparative Example 1 was speculated to be induced by aluminum chloride and 1-ethyl-3-methylimidazolium chloride decomposition, which started at a potential of 2.6V. In contrast, Aluminum-ion battery (3) of Example 2 could be stably charged to 2.6V, and no overreaction was observed even when the charging/discharging exceeded 100 cycles. In addition, in Aluminum-ion battery (2) of Example 1, a plurality of discharging platforms in a range from 2.31V to 2.0V and from 1.95V to 1.5V were observed. The unstable charging/discharging appearance of Aluminum-ion battery (6) of Comparative Example 3 may be caused by the decomposition of aluminum chloride and 1-ethyl-3-methylimidazolium chloride, which started at a potential of 2.6V. Therefore, Electrolyte composition (6) (with 1.5 wt % of Compound (2)) was not effective in increasing the decomposition potential of aluminum chloride and 1-ethyl-3-methylimidazolium chloride.

Next, Aluminum-ion battery (1) of Comparative Example 1, Aluminum-ion battery (3) of Example 2, and Aluminum-ion battery (9) of Example 6 were subjected to a charging/discharging test (charged to 2.75 V and discharged to 0.5 V at a current density of 150 mA/g). As the result, Aluminum-ion battery (1) of Comparative Example 1 could be charged stably to 2.55V, but an inflection point of charging curve was observed when charging voltage was greater than 2.6V. It means that Aluminum-ion battery (1) underwent overcharging. By contrast, Aluminum-ion battery (3) of Example 2 could be stably charged to 2.75V and no inflection point of charging curve was observed. In addition, Aluminum-ion battery (9) of Example 6 could be also charged stably to 2.75V and no inflection point in charging curve was observed.

Next, Aluminum-ion battery (1) of Comparative Example 1, Aluminum-ion battery (3) of Example 2, and Aluminum-ion battery (9) of Example 6 were subjected to a charging/discharging test (charged to about 3.0 V and discharged to about 0.5 V at a current density of about 150 mA/g). The result showed the existence of inflection points in the charging curve of Aluminum-ion battery (1) of Comparative Example 1 during charging/discharging, which indicated that Aluminum-ion battery (1) of Comparative Example 1 was not stable, and the Aluminum-ion battery (1) totally failed when the charging/discharging exceeded 80 cycles. By contrast, the charging curve of Aluminum-ion battery (3) of Example 2 was stable when Aluminum-ion battery (3) was charged to 3.0V. Furthermore, no overcharging phenomenon was observed when the charging/discharging exceeded 500 cycles. In addition, in Aluminum-ion battery (3) of Example 2, a plurality of discharging platforms in a range from 2.35V to 1.95V and from 1.87V to 1.5V were observed. The charging curve of Aluminum-ion battery (9) of Example 6 was stable when Aluminum-ion battery (9) was charged to 3.0V. Furthermore, no overcharging phenomenon was observed when the charging/discharging exceeded 100 cycles.

Accordingly, by means of the addition of Compound (1) in the electrolyte composition or a layer (including compound (1)) fixed on the graphite electrode, the overreaction of the obtained aluminum-ion batteries, which may occur at higher charging/discharging voltage, can be inhibited, thereby improving the high-voltage (charging/discharging voltage) resistance of aluminum-ion battery.

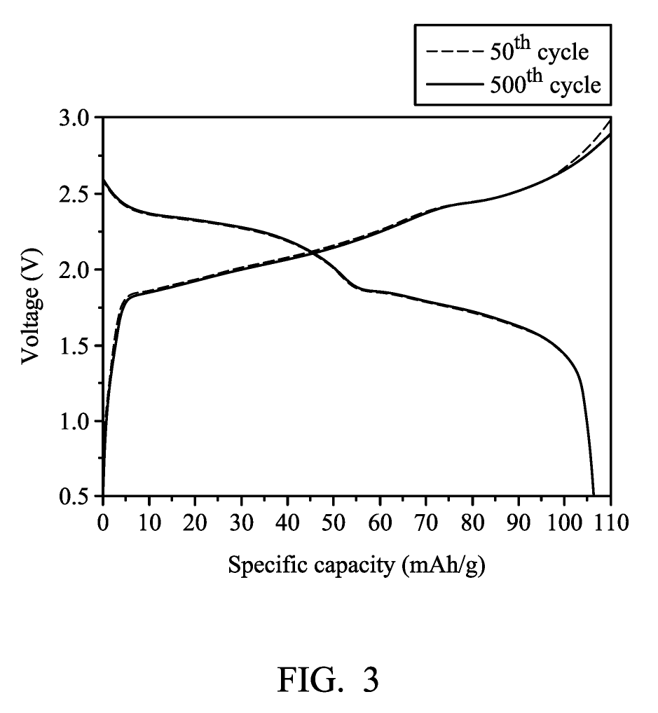

FIG. 3 is a graph plotting the charging/discharging voltage against the specific capacity of Aluminum-ion battery (3) of Example 2 at the 500th charging/discharging cycle, wherein Aluminum-ion battery (3) was charged to about 3.0 V and discharged to about 0.5 V. As shown in FIG. 3, Aluminum-ion battery (3) of Example 2 exhibits superior high-voltage (charging/discharging voltage) resistance, and the electrolyte composition of Aluminum-ion battery (3) was not deteriorated. Therefore, due to the addition of Compound (1), the decomposition potential of electrolyte composition (such as an electrolyte composition including aluminum chloride and 1-ethyl-3-methylimidazolium chloride) can be increased to about 3.0V.

Capacity Retention Test

The initial capacities of Aluminum-ion battery (1) of Comparative Example 1, Aluminum-ion battery (3) of Example 2, and Aluminum-ion battery (5) of Comparative Example 2 were measured, after charging the aluminum-ion batteries to about 2.45 at a current density of about 150 mA/g. Next, the fully charged batteries (Aluminum-ion battery (1) of Comparative Example 1, Aluminum-ion battery (3) of Example 2, and Aluminum-ion battery (5) of Comparative Example 2) were switched to the open-circuit condition at room temperature. After standing for 24 hr, 48 hr, and 96 hr, the capacity of the aforementioned aluminum-ion batteries were measured to determine the capacity retention percentage (in comparison with the initial capacity). The results are shown in Table 2.

TABLE 2

| | | capacity | capacity | |
|---|---|---|---|---|
| | | retention | retention | capacity |
| | Compound (1) | (after | (after | retention (after |
| | (wt %) | 24 hr) (%) | 48 hr) (%) | 96 hr) (%) |
| Aluminum-ion | 0 | 79.21 | 74.81 | 62.83 |
| battery (1) | | | | |
| Aluminum-ion | 1.5 | 81.42 | 76.93 | 70.24 |
| battery (3) | | | | |
| Aluminum-ion | 5 | 79.85 | 75.34 | 64.65 |
| battery (5) | | | | |

As shown in Table 2, in comparison with Aluminum-ion battery (1) (without Compound (1)) or Aluminum-ion battery (5) (including 5 wt % of Compound (1)), aluminum-ion battery (3) (including 1.5 wt % of Compound (1)) indeed exhibits higher charge retention.

Next, Aluminum-ion battery (1) of Comparative Example 1 and Aluminum-ion battery (3) of Example 2 were subjected to a test of self-discharge voltage attenuation, and the test of self-discharge voltage attenuation included following steps. First, Aluminum-ion battery (1) of Comparative Example 1 and Aluminum-ion battery (3) of Example 2 was charged to 2.45V. Next, the fully charged batteries (Aluminum-ion battery (1) of Comparative Example 1 and Aluminum-ion battery (3) of Example 2) were switched to the open-circuit condition at room temperature. After standing for 24 hr, 48 hr, and 96 hr, the capacity of the aforementioned aluminum-ion batteries were measured to determine the self-discharge voltage attenuation. The results are shown in Table 3.

TABLE 3

| | self-discharge | self-discharge | |
|---|---|---|---|
| | voltage | voltage | |
| | attenuation | attenuation | self-discharge voltage |
| | after 12 hr | after 48 hr | attenuation after 96 hr |
| | (V) | (V) | (V) |
| Aluminum-ion | 0.183 | 0.281 | 0.385 |
| battery (1) | | | |
| Aluminum-ion | 0.141 | 0.176 | 0.212 |
| battery (3) | | | |

As shown in Table 3, after standing for 96 hr, the reduced voltage of Aluminum-ion battery (1) of Comparative Example 1 was 385 mV. It was 15.71% compared to the initial voltage (2.45V). By contrast, after standing for 96 hr, the reduced voltage of Aluminum-ion battery (3) of Example 2 was 212 mV. It was 8.65% compared to the initial voltage (2.45V). Accordingly, the voltage descent rate of Aluminum-ion battery (3) of Example 2 after standing for a while is slower than that of Aluminum-ion battery (1) of Comparative Example 1.

It will be clear that various modifications and variations can be made to the disclosed methods and materials. It is intended that the specification and examples be considered as exemplary only, with the true scope of the disclosure being indicated by the following claims and their equivalents.

What is claimed is:

1. An aluminum-ion battery, comprising:
a positive electrode;
a separator;
a negative electrode, wherein the negative electrode is separated from the positive electrode by the separator; and
an electrolyte composition disposed between the positive electrode and the negative electrode, wherein the electrolyte composition comprises:
an aluminum halide;
a solvent, wherein the sum of the aluminum halide and the solvent is 100 parts by weight; and
a compound of Formula (I) 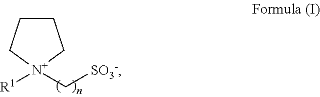
wherein R¹ is C₁₋₈ alkyl group or C₁₋₈ fluoroalkyl group; and n is 2, 3, 4, or 5, and wherein the compound of Formula (I) has a weight that is equal to or greater than 0.5 parts by weight and less than 5 parts by weight.

2. The aluminum-ion battery as claimed in claim 1, wherein the molar ratio of the aluminum halide to the solvent is from 1:1 to 2.2:1.

3. The aluminum-ion battery as claimed in claim 1, wherein the solvent is ionic liquid.

4. The aluminum-ion battery as claimed in claim 3, wherein the ionic liquid is ammonium chloride, azaannulenium chloride, azathiazolium chloride, benzimidazolium chloride, benzofuranium chloride, benzotriazolium chloride, borolium chloride, cholinium chloride, cinnolinium chloride, diazabicyclodecenium chloride, diazabicyclononenium chloride, diazabicyclo-undecenium chloride, dithiazolium chloride, furanium chloride, guanidinium chloride, imidazolium chloride, indazolium chloride, indolinium chloride, indolium chloride, morpholinium chloride, oxaborolium chloride, oxaphospholium chloride, oxazinium chloride, oxazolium chloride, iso-oxazolium chloride, oxathiazolium chloride, pentazolium chloride, phospholium chloride, phosphonium chloride, phthalazinium chloride, piperazinium chloride, piperidinium chloride, pyranium chloride, pyrazinium chloride, pyrazolium chloride, pyridazinium chloride, pyridinium chloride, pyrimidinium chloride, pyrrolidinium chloride, pyrrolium chloride, quinazolinium chloride, quinolinium chloride, iso-quinolinium chloride, quinoxalinium chloride, selenozolium chloride, sulfonium chloride, tetrazolium chloride, iso-thiadiazolium chloride, thiazinium chloride, thiazolium chloride, thiophenium chloride, thiuronium chloride, triazadecenium chloride, triazinium chloride, triazolium chloride, iso-triazolium chloride, uronium chloride, or a combination thereof.

5. The aluminum-ion battery as claimed in claim 1, wherein the solvent is organic solvent.

6. The aluminum-ion battery as claimed in claim 5, wherein the organic solvent is urea, N-methylurea, dimethyl sulfoxide, methylsulfonylmethane, or a combination thereof.

7. The aluminum-ion battery as claimed in claim 1, wherein R¹ is methyl group, ethyl group, propyl group, isopropyl group, butyl group, sec-butyl group, iso-butyl group, tert-butyl group, pentyl group, hexyl group, fluoromethyl, fluoroethyl, fluoropropyl, fluoroisopropyl group, fluorobutyl group, fluoro-sec-butyl group, fluoro-iso-butyl group, fluoro-tert-butyl group, fluoropentyl group, or fluorohexyl group.

8. The aluminum-ion battery as claimed in claim 1, wherein the compound of Formula (I) is 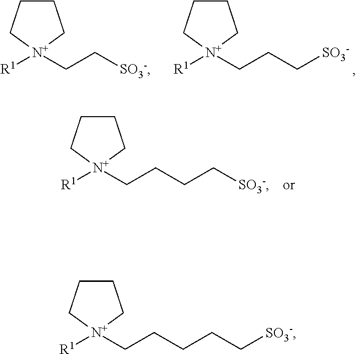
wherein R¹ is C₁₋₈ alkyl group or C₁₋₈ fluoroalkyl group.

9. The aluminum-ion battery as claimed in claim 1, wherein the compound of Formula (I) is 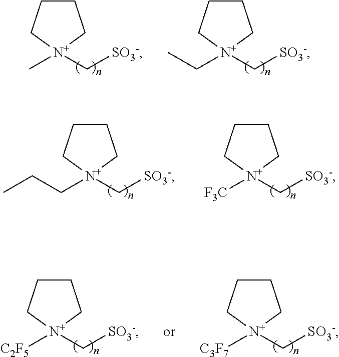
wherein n is 2, 3, 4, or 5.

10. The aluminum-ion battery as claimed in claim 1, wherein the positive electrode comprises a current-collecting layer and an active material layer, and the active material layer comprises an active material.

11. The aluminum-ion battery as claimed in claim 10, wherein the current-collecting layer is a conductive carbon substrate.

12. The aluminum-ion battery as claimed in claim 11, wherein the conductive carbon substrate is carbon cloth, carbon felt, or carbon paper.

13. The aluminum-ion battery as claimed in claim 10, wherein the active material is layered carbon material, vanadium oxide, or metal sulfide.

14. The aluminum-ion battery as claimed in claim 13, wherein the layered carbon material is graphite, carbon nanotube, graphene, or a combination thereof.

15. The aluminum-ion battery as claimed in claim 14, wherein the graphite is natural graphite, synthetic graphite, pyrolytic graphite, foamed graphite, flake graphite, expanded graphite, or a combination thereof.

16. The aluminum-ion battery as claimed in claim 1, wherein the negative electrode comprises a metal or an alloy of the metal.

17. The aluminum-ion battery as claimed in claim 16, wherein the metal or the alloy of the metal comprises aluminum, copper, iron, zinc, indium, nickel, tin, chromium, yttrium, titanium, manganese, or molybdenum.

18. The aluminum-ion battery as claimed in claim 1, wherein the separator is glass fiber, polyethylene (PE), polypropylene (PP), nonwoven fabric, wood fiber, poly(ether sulfones) (PES), ceramic fiber, or a combination thereof.

19. An aluminum-ion battery, comprising:
a positive electrode comprising a current-collecting layer, an active material disposed on the current-collecting layer, and a zwitterionic compound layer disposed on the active material layer, wherein the zwitterionic compound layer comprises a compound of Formula (I) 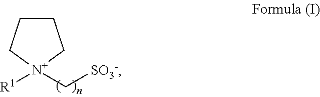
wherein R¹ is C₁₋₈ alkyl group or C₁₋₈ fluoroalkyl group; and n is 2, 3, 4, or 5;
a separator;
a negative electrode, wherein the negative electrode is separated from the positive electrode by the separator; and
an electrolyte composition disposed between the positive electrode and the negative electrode, wherein the electrolyte composition comprises an aluminum halide and a solvent.

20. The aluminum-ion battery as claimed in claim 19, wherein R¹ is methyl group, ethyl group, propyl group, isopropyl group, butyl group, sec-butyl group, iso-butyl group, tert-butyl group, pentyl group, hexyl group, fluoromethyl, fluoroethyl, fluoropropyl, fluoroisopropyl group, fluorobutyl group, fluoro-sec-butyl group, fluoro-iso-butyl group, fluoro-tert-butyl group, fluoropentyl group, or fluorohexyl group.

21. The aluminum-ion battery as claimed in claim 19, wherein the compound of Formula (I) is 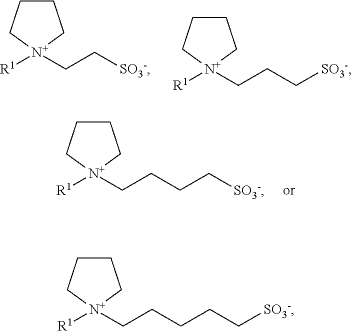
wherein R¹ is C₁₋₈ alkyl group or C₁₋₈ fluoroalkyl group.

22. The aluminum-ion battery as claimed in claim 19, wherein the compound of Formula (I) is 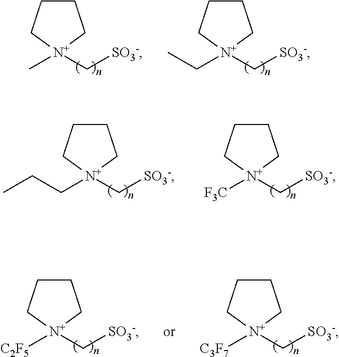
wherein n is 2, 3, 4, or 5.

23. The aluminum-ion battery as claimed in claim 19, wherein the electrolyte composition further comprises compound of Formula (I) 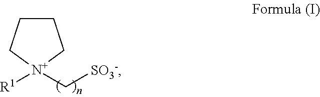
wherein R¹ is C₁₋₈ alkyl group or C₁₋₈ fluoroalkyl group; and n is 2, 3, 4, or 5.
